(19) United States
(12) Patent Application Publication
(10) Pub. No.: US 2026/0300824 A1
(43) Pub. Date: Oct. 1, 2026

(54) TRAINING DEVICE, TRAINING METHOD, AND STORAGE MEDIUM

(71) Applicant: NEC Corporation, Tokyo (JP)

(72) Inventors: Yusuke AKAMATSU, Tokyo (JP); Terumi UMEMATSU, Tokyo (JP)

(73) Assignee: NEC Corporation, Tokyo (JP)

(21) Appl. No.: 19/477,550

(22) PCT Filed: May 30, 2023
(86) PCT No.: PCT/JP2023/020077

§ 371 Date: Oct. 22, 2025

(51) Int. Cl. G06N 20/00; G06V 10/774; G06V 20/40

(52) U.S. Cl. CPC G06N 20/00; G06V 10/7747; G06V 20/46

(57) ABSTRACT

A training device 1X mainly includes a feature information acquisition means 15X and a training means 17X. The feature information acquisition means 15X is configured to acquire first feature information that is spatiotemporal feature information generated from a first video obtained by photographing a subject by a first camera, and acquiring second feature information that is the feature information generated from a second video obtained by photographing the subject by a second camera. The training means 17X is configured to train, based on the first feature information and the second feature information, an inference model that infers a relationship between the feature information and state information of the subject. The inference model obtained through such machine learning can be used to assist user's decision making.

### TECHNICAL FIELD

The present disclosure relates to the technical field of a training device, a training method, and a storage medium.

### BACKGROUND

There is a technique for estimating vital information using a biological video captured by a camera. For example, PTL 1 discloses a technique of estimating information regarding a pulse from a captured image of a user's face using a trained machine learning model.

### CITATION LIST

### Patent Literature

PTL 1: JP 2021-069813 A

### SUMMARY

### Problem to be Solved

In general, training of a machine learning model for inferring vital information requires a supervised label acquired by a sensor such as a pulse wave sensor or a breathing band attached to a subject. Data collection with these sensors is burdened on the subject and the data collector.

In view of the above-described problems, an object of the present disclosure is to provide a training device, a training method, and a storage medium capable of suitably executing training of a machine learning model that performs inference regarding a state of a subject.

### Means for Solving the Problem

One mode of the training device is a training device including:
a feature information acquisition means for acquiring first feature information that is spatiotemporal feature information generated from a first video obtained by photographing a subject by a first camera, and acquiring second feature information that is the feature information generated from a second video obtained by photographing the subject by a second camera; and
a training means for training, based on the first feature information and the second feature information, an inference model that infers a relationship between the feature information and state information of the subject,
wherein the training means performs the training using, as a positive pair, the first feature information and the second feature information which are based on videos obtained by photographing the same subject in a same period.

One mode of the training method is a training method including:
acquiring first feature information that is spatiotemporal feature information generated from a first video obtained by photographing a subject by a first camera, and acquiring second feature information that is the feature information generated from a second video obtained by photographing the subject by a second camera; and
training, based on the first feature information and the second feature information, an inference model that infers a relationship between the feature information and state information of the subject,
performing the training using, as a positive pair, the first feature information and the second feature information which are based on videos obtained by photographing the same subject in a same period.

One mode of the storage medium is a storage medium storing a program executed by a computer, the program causing the computer to execute processing including:
acquiring first feature information that is spatiotemporal feature information generated from a first video obtained by photographing a subject by a first camera, and acquiring second feature information that is the feature information generated from a second video obtained by photographing the subject by a second camera; and
training, based on the first feature information and the second feature information, an inference model that infers a relationship between the feature information and state information of the subject,
performing the training using, as a positive pair, the first feature information and the second feature information which are based on videos obtained by photographing the same subject in a same period.

### Effect

An example advantage according to the present invention is to suitably execute training of a machine learning model that performs inference regarding a state of a subject.

### BRIEF DESCRIPTION OF THE DRAWINGS

FIG. 1 is a schematic configuration of a vital information estimation system according to an example embodiment.

FIG. 2A illustrates an example of a hardware configuration of a training device. FIG. 2B illustrates an example of a hardware configuration of an estimation device.

FIG. 3 illustrates an outline of processing of performing contrastive learning between a first inference model for a first camera and a second inference model for a second camera by using clip videos generated from the first camera and the second camera.

FIG. 4 illustrates an example of functional blocks of a training device.

FIG. 5 is a schematic diagram of data augmentation.

FIG. 6 is an example of functional blocks of an estimation device related to estimation processing of vital information using a trained inference model.

FIG. 7 is an example of a flowchart illustrating a processing procedure by the training device.

FIG. 8 illustrates an outline of training of an inference model in a modification.

FIG. 9 illustrates an overall configuration of a training device according to a second example embodiment.

FIG. 10 is an example of a flowchart illustrating a processing procedure executed by the training device in the second example embodiment.

### EXAMPLE EMBODIMENT

Hereinafter, example embodiments of a training device, a training method, and a storage medium will be described with reference to the drawings.

### First Example Embodiment

### (1) Overall Configuration

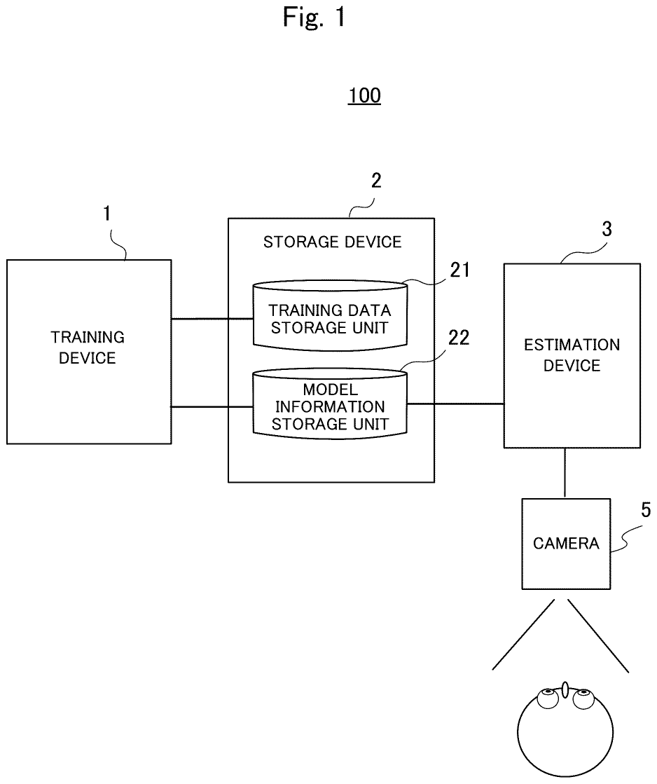

FIG. 1 is a schematic configuration of a vital information estimation system 100 according to a first example embodiment. The vital information estimation system 100 performs processing related to estimation of vital information of the subject captured by a camera. The vital information estimation system 100 mainly includes a training device 1, a storage device 2, an estimation device 3, and a camera 5. The training device 1 and the storage device 2, the storage device 2 and the estimation device 3, and the estimation device 3 and the camera 5 perform data communication in a wired or wireless manner. These communications may be performed via a network.

The training device 1 performs processing related to training of a machine learning model used for estimating vital information. The estimated vital information includes, for example, information about any vital parameter such as heart rate, respiration, SpO2, blood pressure, etc. The training device 1 trains a machine learning model serving as an inference engine that performs inference regarding vital information based on training data stored in a training data storage unit 21 of the storage device 2, and stores parameters and the like of the machine learning model obtained by training in a model information storage unit 22.

The storage device 2 stores information necessary for processing executed by the training device 1 and the storage device 2. The storage device 2 functionally includes the training data storage unit 21 and the model information storage unit 22.

The training data storage unit 21 stores training data that is data for training (training) used for the training device 1 to train the machine learning model. Here, the training data includes video data in which a person is a subject. The video data is used for contrastive learning of an inference model to be described later. Hereinafter, video data (for example, video data of a predetermined time length) used for generating input data for one time to the machine learning model is also referred to as a “clip video”. Here, the training data includes clip videos generated by a plurality of cameras, and the clip videos generated by the plurality of cameras include clip videos generated from the plurality of cameras by simultaneously photographing the same subject by the plurality of cameras.

The clip video is not limited to the video of the face of the subject, and may be a video in which the skin of a hand or other arbitrary portion is captured. The clip video may be a video in which a plurality of places of the subject are captured. The subject is not limited to a human, and may be an animal other than a human.

The model information storage unit 22 stores model information related to an inference model that is a machine learning model to be trained by the training device 1. The model information includes parameters of an inference model updated by training executed by the training device 1. In the present example embodiment, as an example, it is assumed that the inference model is a camera-dependent model (that is, the model trained using the input data based on the clip video generated from the specific camera) trained for each camera. Therefore, there are as many inference models as the number of cameras used to capture the clip video stored in the training data storage unit 21. The model information of each inference model is stored in the model information storage unit 22 in association with, for example, identification information of the relevant camera.

The inference model is a model that outputs an inference result regarding the vital information at the time of photographing the subject of the clip video in a case where input data based on the clip video is input to the inference model, in other words, a model that has trained the relationship between the clip video and the vital information of the subject of the clip video. The inference result output by the inference model may be a waveform related to the vital parameter such as a pulse wave or a respiratory waveform, or may be an index related to the vital parameter such as a heart rate or a respiratory rate. Here, the architecture of the inference model may be a neural network (transformer, any other convolutional neural network, etc.), may be another type of architecture such as a support vector machine, or may be an architecture combining them. When an architecture based on a neural network such as a convolutional neural network is used for an inference model, the model information storage unit 22 stores information regarding various parameters (including hyperparameters), such as a layer structure of the inference model, a neuron structure of each layer, the number of filters and a filter size in each layer, a weight of each element of each filter, and the like.

The storage device 2 may be an external storage device such as a hard disk connected to or incorporated in the training device 1 or the estimation device 3, may be a storage medium such as a flash memory, or may be a server device or the like that performs data communication with the training device 1 and the estimation device 3. The storage device 2 may include a plurality of storage devices, and each of the above-described storage units may be held in a distributed manner.

The estimation device 3 estimates vital information of the subject based on video data generated by the camera 5 that photographs the subject. In this case, the estimation device 3 extracts the model information of the inference model relevant to the camera 5 from the model information storage unit 22, and configures the trained inference model relevant to the camera 5. Then, the estimation device 3 extracts the clip video from the video data generated by the camera 5, and inputs input data based on the extracted clip video to the trained inference model. Then, the estimation device 3 acquires vital information based on the inference result output by the inference model.

The camera 5 is a camera that captures an image of a subject, and supplies the generated video data to the estimation device 3. The camera 5 may be relevant to any camera used for generating the clip video stored in the training data storage unit 21.

The configuration of the vital information estimation system 100 illustrated in FIG. 1 is an example, and various changes may be made. For example, at least two of the training device 1, the storage device 2, and the estimation device 3 may be implemented by the same device. As another example, the training device 1 and the estimation device 3 may each include a plurality of devices. In that case, the plurality of devices included in the training device 1 and the plurality of devices included in the estimation device 3 exchange information required to execute pre-assigned processing between the devices by wired or wireless direct communication or by communication via a network. The vital information estimation system 100 may generate a clip video serving as training data based on video data output from the camera 5 or the like, and store the generated clip video in the training data storage unit 21.

### (2) Hardware Configuration

Next, each hardware configuration of the training device 1 and the estimation device 3 will be described.

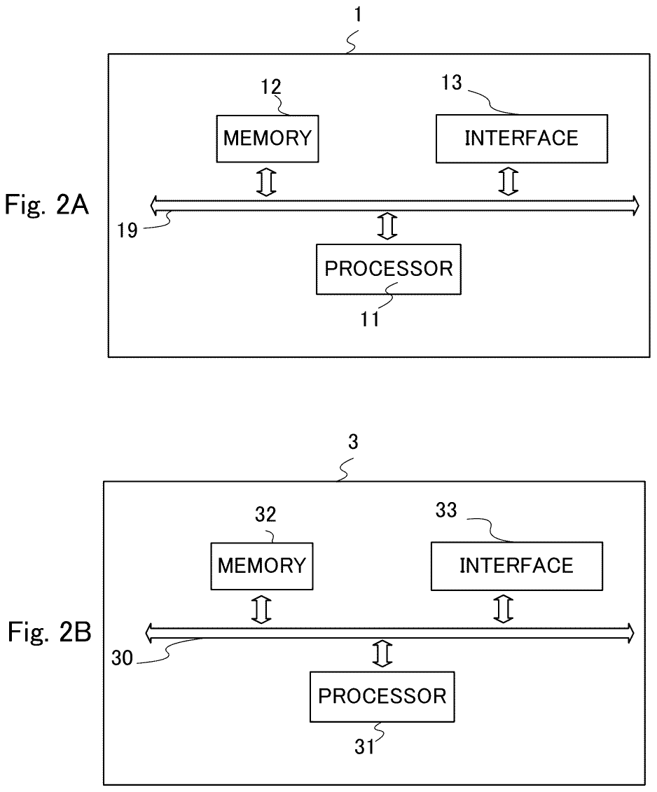

FIG. 2A illustrates a hardware configuration of the training device 1. The training device 1 includes, as hardware, a processor 11, a memory 12, and an interface 13. The processor 11, the memory 12, and the interface 13 are coupled to each other via a data bus 19.

The processor 11 functions as a controller (arithmetic device) that takes overall control of the training device 1 by executing a program stored in the memory 12. Examples of the processor 11 include a central processing unit (CPU), a graphics processing unit (GPU), and a tensor processing unit (TPU). The processor 11 may include a plurality of processors. The processor 11 is an example of a computer.

The memory 12 includes various volatile memories and nonvolatile memories, such as a random access memory (RAM), a read only memory (ROM), and a flash memory. The memory 12 stores a program for executing processing to be performed by the training device 1. A part of the information stored in the memory 12 may be stored in an external storage device such as the storage device 2 capable of communicating with the training device 1, or may be stored in a storage medium detachable from the training device 1. The memory 12 may store the information stored in the storage device 2 instead.

The interface 13 is an interface for electrically connecting the training device 1 and another device. These interfaces may be a wireless interface such as a network adapter for wirelessly transmitting and receiving data to and from the another device, or may be a hardware interface for connecting to the another device by a cable or the like.

FIG. 2B illustrates an example of a hardware configuration of the estimation device 3. The estimation device 3 includes, as hardware, a processor 31, a memory 32, and an interface 33. The processor 31, the memory 32, and the interface 33 are coupled to each other via a data bus 30.

The processor 31 functions as a controller (arithmetic device) that takes overall control of the estimation device 3 by executing a program stored in the memory 32. The processor 31 is, for example, a processor such as a CPU, a GPU, or a TPU. The processor 31 may include a plurality of processors.

The memory 32 includes various volatile memories, such as a RAM, a ROM, a flash memory, and the like, and a nonvolatile memory. The memory 32 stores a program for executing processing to be performed by the estimation device 3. A part of the information stored in the memory 32 may be stored in an external storage device such as the storage device 2 capable of communicating with the estimation device 3, or may be stored in a storage medium detachable from the estimation device 3. The memory 32 may store the information stored in the storage device 2 instead.

The interface 33 is an interface for electrically connecting the estimation device 3 and another device. These interfaces may be a wireless interface such as a network adapter for wirelessly transmitting and receiving data to and from the another device, or may be a hardware interface for connecting to the another device by a cable or the like.

The hardware configurations of the training device 1 and the estimation device 3 are not limited to the configurations illustrated in FIGS. 2A and 2B. For example, either the training device 1 or the estimation device 3 may further include a display unit such as a display, an input unit such as a keyboard and a mouse, an audio output unit such as a speaker, and the like.

### (3) Outline of Training

Next, an outline of training of the inference model by the training device 1 will be described. The training device 1 performs contrastive learning of the inference model assuming that the pieces of vital information based on the clip videos obtained by simultaneously photographing the same subject by the two cameras are similar to each other, and the pieces of vital information based on the clip videos having different subjects or different photographing periods are not similar to each other. Specifically, for the inference model for each camera that generates the clip video, the training device 1 performs contrastive learning such that the inference results based on the clip videos obtained by simultaneously photographing the same subject are brought close, and the inference results based on the clip videos having different subjects or different photographing times are moved away. As a result, the inference model for the specific camera is trained without requiring a supervised label.

A set of clip videos obtained by simultaneously photographing the same subject, a set of feature information generated based on the clip videos, or a set of inference results based on the feature information is a pair (that is, a pair of positive examples) treated as information based on substantially the same subject state (substantially the same vital parameter) in the contrastive learning, and hereinafter, these sets are also referred to as “positive pairs”. On the other hand, a set of clip videos in which at least one of the subject or the photographing period is different, a set of feature information generated based on the clip videos, or a set of inference results based on the feature information is a pair (that is, a pair of negative examples) treated as information based on substantially different states (substantially different vital parameters) of the subject in the contrastive learning, and hereinafter, these sets are also referred to as “negative pairs”.

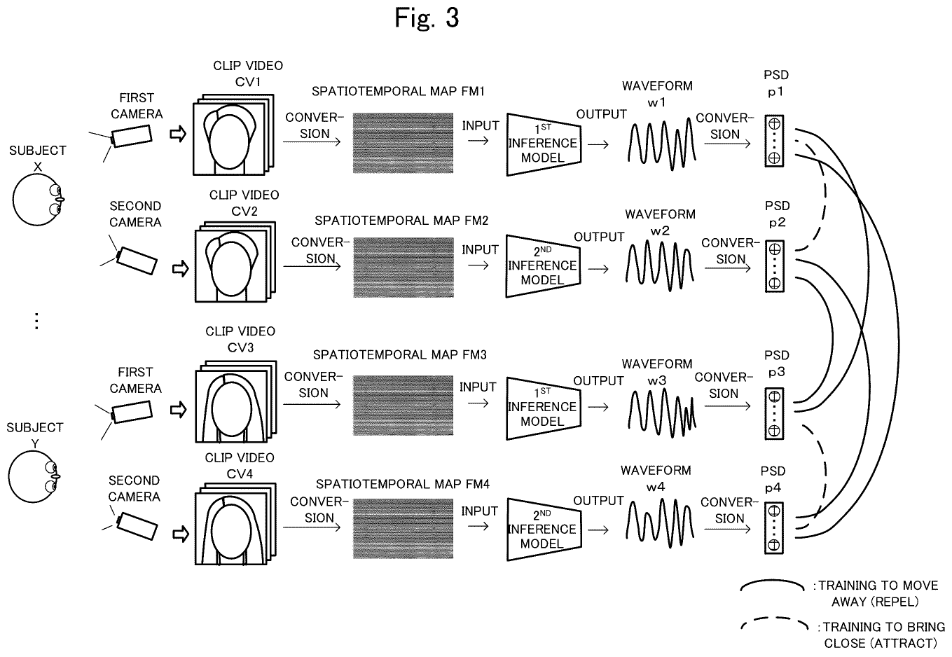

FIG. 3 illustrates an outline of processing of performing contrastive learning between a first inference model that is an inference model for the first camera and a second inference model that is an inference model for the second camera by using clip videos generated from the first camera and the second camera. Here, it is assumed that each of the first inference model and the second inference model is a machine learning model that outputs a vital waveform such as a pulse wave or a respiratory waveform when a spatiotemporal feature map (It is also referred to as a “spatiotemporal map”) obtained by converting the clip video is input.

In FIG. 3, a subject X is simultaneously captured by the first camera and the second camera, so that a clip video CV1 is generated by the first camera and a clip video CV2 is generated by the second camera. A subject Y is simultaneously captured by the first camera and the second camera, so that a clip video CV3 is generated by the first camera and a clip video CV4 is generated by the second camera. Each of the pair of the clip video CV1 and the clip video CV2 and the pair of the clip video CV3 and the clip video CV4 is a positive pair. In FIG. 3, only two videos of the subject X and the subject Y are displayed, but a plurality of videos more than two videos are actually used.

Then, the training device 1 converts the clip videos CV1 to CV4 into spatiotemporal maps FM1 to FM4. Here, the spatiotemporal maps FM1 to FM4 are data generated by feature extraction of the clip videos CV1 to CV4, and are data in a tensor format matching the input formats of the first inference model and the second inference model. The training device 1 may increase the number of records of the clip video used for the contrastive learning by performing data augmentation (data augmentation) on the clip videos CV1 to CV4.

Next, the training device 1 acquires a waveform w1 output by the first inference model by inputting the spatiotemporal map FM1 relevant to the clip video CV1 generated by the first camera to the first inference model for the first camera. Similarly, the training device 1 acquires a waveform w3 output by the first inference model by inputting the spatiotemporal map FM3 relevant to the clip video CV3 generated by the first camera to the first inference model for the first camera. Next, the training device 1 acquires a waveform w2 output by the second inference model by inputting the spatiotemporal map FM2 relevant to the clip video CV2 generated by the second camera to the second inference model for the second camera. Similarly, the training device 1 acquires a waveform w4 output by the second inference model by inputting the spatiotemporal map FM4 relevant to the clip video CV4 generated by the second camera to the second inference model for the second camera.

Then, the training device 1 converts the waveforms w1 to w4 into power spectrum densities (PSDs) p1 to p4. The PSD expresses frequency characteristics, and is relevant to information capable of acquiring a vital parameter such as a heart rate and a respiratory rate.

Then, the training device 1 performs contrastive learning of the first inference model and the second inference model so as to bring the PSD p1 and the PSD p2 relevant to the inference results of the first inference model and the second inference model close (i.e., so that the PSD p1 and the PSD p2 attract each other), based on the clip videos CV1 and CV2 of the positive pair obtained by simultaneously photographing the same subject X. Similarly, the training device 1 performs contrastive learning of the first inference model and the second inference model so as to bring the PSD p3 and the PSD p4 relevant to the inference results of the first inference model and the second inference model close based on the clip videos CV3 and CV4 of the positive pair obtained by simultaneously photographing the same subject Y.

On the other hand, the training device 1 performs contrastive learning of the first inference model so as to move away the PSD p1 and the PSD p3 relevant to the inference results of the first inference model (i.e., so that the PSD p1 and the PSD p3 repel each other), based on the clip videos CV1 and CV3 obtained by photographing different subjects in different photographing periods. The training device 1 performs contrastive learning of the first inference model so as to move away the PSD p2 and the PSD p4 relevant to the inference results of the second inference model based on the clip videos CV2 and CV4 obtained by photographing different subjects in different photographing periods. Similarly, the training device 1 performs contrastive learning of the first inference model and the second inference model so as to move away the PSD p1 and the PSD p4 relevant to the inference results of the first inference model and the second inference model based on the clip videos CV1 and CV4 obtained by photographing different subjects X and Y. The training device 1 performs contrastive learning of the second inference model and the first inference model so as to move away the PSD p2 and the PSD p3 relevant to the inference results of the second inference model and the first inference model based on the clip videos CV2 and CV3 obtained by photographing different subjects X and Y. Although not illustrated in FIG. 3, clip videos captured in different photographing periods of the same subject are an example of a negative pair.

In this case, the training device 1 sets a loss function that brings the inference results (the PSD p1, the PSD p2, and the like) forming a positive pair close and brings the inference results (the PSD p1, the PSD p3, and the like) forming a negative pair away, and determines the parameters of the first inference model and the second inference model so as to minimize the loss function. An algorithm for determining the parameters described above in such a way may be any training algorithm used in machine learning such as gradient descent or back propagation.

As described above, the training device 1 regards the vital information inferred based on the clip videos obtained by simultaneously photographing the same subject by the two cameras as a positive pair, and regards the vital information inferred based on the clip videos obtained by different subjects or different photographing periods as a negative pair, and performs contrastive learning of the first inference model and the second inference model. As a result, it is possible to construct an inference model specialized for a specific camera without requiring a supervised label.

### (4) Function Blocks

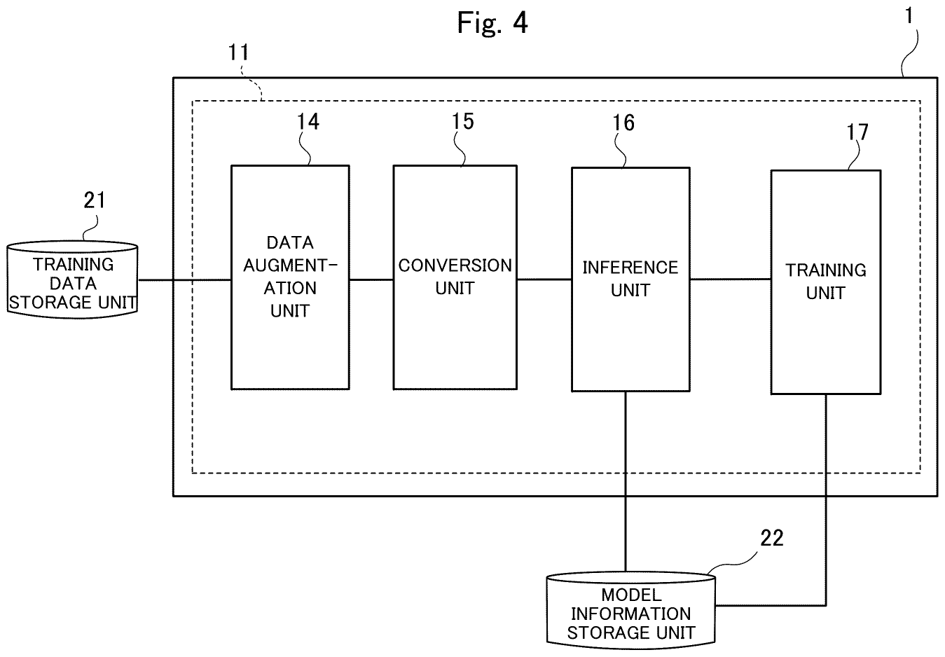

FIG. 4 is an example of functional blocks of the training device 1. As illustrated in FIG. 4, the processor 11 of the training device 1 functionally includes a data augmentation unit 14, a conversion unit 15, an inference unit 16, and a training unit (training unit) 17. While blocks that exchange data with each other are connected by a solid line in FIG. 4, a combination of the blocks that exchange data with each other is not limited to FIG. 4. The same applies to diagrams of other functional blocks described later.

In the following description, as a premise, it is assumed that the training data storage unit 21 includes a clip video of a positive pair obtained by simultaneously photographing the same subject by the first camera and the second camera and a clip video of a negative pair obtained by photographing at least one of the subject or the photographing period by the first camera and the second camera differently. Then, the training device 1 determines the parameter of the first inference model relevant to the first camera and the parameter of the second inference model relevant to the second camera by contrastive learning.

The data augmentation unit 14 extracts a clip video used for training from the training data storage unit 21, and performs data augmentation (temporal augmentation) on the extracted clip video. As a result, the data augmentation unit 14 generates a clip video (also referred to as an “augmented clip video”) indicating vital information different from that of the clip video (also referred to as “original clip video”) to which the data augmentation is applied. Specifically, the data augmentation unit 14 generates the augmented clip video by performing upsampling or downsampling of the number of frames of the original clip video. For example, in the estimation of the heart rate or the respiratory rate, the data augmentation unit 14 performs downsampling of the original clip video to generate an augmented clip video obtained by speeding up (that is, the heart rate or the respiratory rate is increased) the original clip video. The data augmentation unit 14 performs upsampling of the original clip video to generate an augmented clip video in which the speed of the original clip video is reduced (that is, the heart rate or the respiratory rate is decreased). The downsampling rate or the upsampling rate may be any value. Furthermore, the data augmentation unit 14 may perform data augmentation (rotation, inversion, cutout, color conversion, and the like) related to a generally used image in addition to the data augmentation related to time.

Here, the data augmentation unit 14 may apply data augmentation regarding the same time to the positive pair of clip videos obtained by simultaneously photographing the same subject. In this way, the augmented clip video generated by applying the data augmentation regarding the same time to the original clip video of the positive pair is also a positive pair. Therefore, the data augmentation unit 14 can generate the augmented clip video of the positive pair and increase the number of samples of the positive pair. Since a negative pair can be configured from augmented clip videos of different positive pairs, the number of samples of the negative pair can be increased together with the number of samples of the positive pair. With respect to the data augmentation regarding the image, the data augmentation unit 14 may perform different data augmentation also on the clip video in the positive pair. This is because there is a case where it can be assumed that the vital information is the same even if different data augmentations are applied to the clip video of the positive pair.

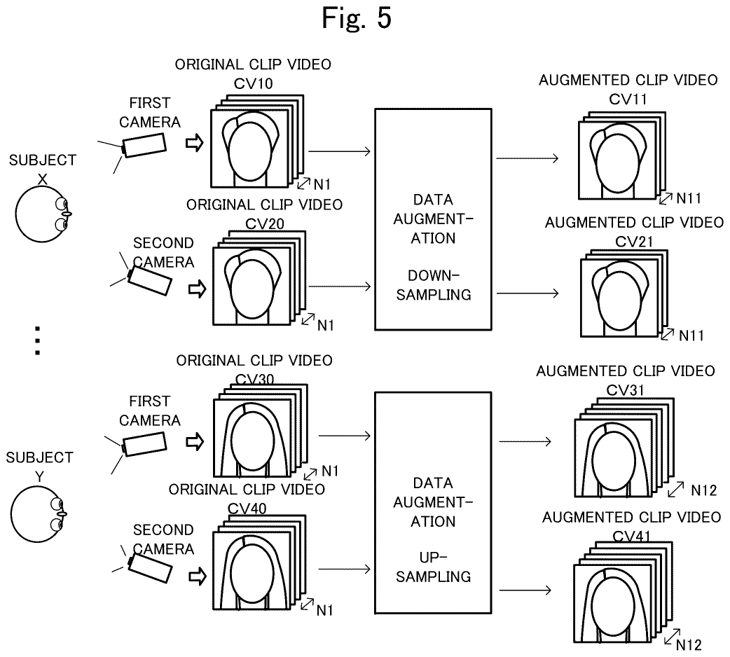

FIG. 5 is a schematic diagram of data augmentation by the data augmentation unit 14. In FIG. 5, the same data augmentation (here, downsampling with a predetermined downsampling rate) is applied to the clip video CV10 and the clip video CV20 of the number of frames “N1” generated by the first camera and the second camera photographing the subject X at the same time. As a result, the augmented clip video CV11 and the augmented clip video CV21 of the number of frames “N11” (here, N11<N1) are generated. The augmented clip video CV11 and the augmented clip video CV21 become a positive pair of the clip videos. Similarly, the same data augmentation (here, upsampling at a predetermined upsampling rate is performed) is applied to the clip video CV30 and the clip video CV40 of the number of frames N1 generated by the first camera and the second camera simultaneously photographing the subject Y. As a result, the augmented clip video CV31 and the augmented clip video CV41 of the number of frames “N12” (here, N12>N1) are generated. The augmented clip video CV31 and the augmented clip video CV41 become a positive pair of the clip videos.

The functional block configuration of the training device 1 will be described again with reference to FIG. 4.

The conversion unit 15 converts the clip video (the same applies hereinafter, including the original clip video and the augmented clip video) supplied from the data augmentation unit 14 into a spatiotemporal map that is a tensor matching the input format of the inference model. Here, as an example, it is assumed that the inference model is a two-dimensional convolutional neural network, and the conversion unit 15 performs conversion into a spatiotemporal map in which features of time and space are represented two-dimensionally. Then, the conversion unit 15 supplies the converted spatiotemporal map to the inference unit 16.

Here, a specific example of generation of the spatiotemporal map will be described.

For example, in a case of generating a spatiotemporal map used for heart rate estimation, the conversion unit 15 extracts a block region (RGB signal) under the eyes including the mouth and the nose from the face region of each image of the clip video based on an arbitrary image recognition technology, and generates a matrix signal having a row direction as a spatial direction and a column direction as a temporal direction as a spatiotemporal map. There are three channels of RGB in the spatiotemporal map. In this case, for example, the matrix signal is obtained by arranging the pixel values of the plurality of block regions extracted from each frame constituting the clip video in the row direction (spatial direction) and arranging the chronological information of the pixel values of each block region in the column direction (temporal direction). In the generation of the matrix signal, the conversion unit 15 may perform processing of reducing the resolution of the block region. By the processing described above, a spatiotemporal map related to the RGB signal based on a minute change in reflected light with the cardiac cycle in the face is generated, and this spatiotemporal map is suitably used for estimation of the pulse wave.

As another example, in a case of generating a spatiotemporal map used for respiration estimation, the conversion unit 15 extracts a region near the chest from the face region of each image of the clip video by an arbitrary image recognition technology, and generates an optical flow signal in the vertical direction at a plurality of feature points in the extracted region near the chest. The optical flow signal captures the motion of the object between frames in the moving image, and is relevant to a signal representing the motion of the chest accompanying the breathing motion here. Since the breathing motion is a motion in a vertical direction, an optical flow signal of one channel in the vertical direction at a plurality of feature points is extracted. Then, the conversion unit 15 arranges the plurality of feature points of the optical flow signal of each frame constituting the clip video in the row direction (spatial direction), and generates the spatiotemporal map in which the chronological information of each feature point is arranged in the column direction (temporal direction). There is one channel of the optical flow signal in the spatiotemporal map. By the above processing, the spatiotemporal map regarding the motion of the chest in the vertical direction based on the breathing motion is generated, and this spatiotemporal map is suitably used for estimation of respiration.

The conversion unit 15 may execute the extraction of the block region under the eyes and the extraction of the region near the chest described above based on an external input by the user. In this case, the conversion unit 15 may display each image of the clip video on a display unit (not illustrated) and receive a user input designating a region to be extracted.

The generation of the spatiotemporal map is not limited to the above-described specific example. For example, in the heart rate estimation, the conversion unit 15 may generate the spatiotemporal map using any one channel or two channels instead of using three channels of RGB signals. In another example, in the respiration estimation, the conversion unit 15 may generate the spatiotemporal map by using the RGB signal instead of the optical flow signal. A spatiotemporal map may be generated by combining the optical flow signal and the RGB signal. In still another example, in a case where a feature extractor is obtained by training in advance, the conversion unit 15 may acquire the spatiotemporal map output by the feature extractor by inputting the video clip to the feature extractor. In this case, the trained parameters of the feature extractor and the like are stored in advance in the storage device 2 and the like, and the conversion unit 15 acquires the spatiotemporal map output by the feature extractor by inputting the video clip to the feature extractor.

The inference unit 16 generates an inference result regarding the vital information based on the spatiotemporal map supplied from the conversion unit 15 and the inference model (the first inference model or the second inference model) configured based on the model information stored in the model information storage unit 22. Here, for the spatiotemporal map based on the clip video generated by the first camera, the inference unit 16 acquires the inference result output by the first inference model by inputting the spatiotemporal map to the first inference model. On the other hand, for the spatiotemporal map based on the clip video generated by the second camera, the inference unit 16 acquires the inference result output by the second inference model by inputting the spatiotemporal map to the second inference model.

The training unit 17 performs contrastive learning of updating the parameters of the first inference model and the second inference model based on an arbitrary inference result supplied from the inference unit 16. In this case, the training unit 17 uses a loss function that brings the inference results forming a positive pair closer and brings the inference results forming a negative pair away, and determines the parameters of the first inference model and the second inference model so as to minimize the loss function. An algorithm for determining the parameters described above in such a way may be any training algorithm used in machine learning such as gradient descent or back propagation.

Here, a specific example of the loss function will be described. Here, a case where N (N is an integer of 2 or more) sets of positive pair clip videos are generated will be described. In this case, there are clip videos of N first cameras, and there are clip videos of N second cameras.

Here, the training unit 17 calculates, for example, a loss function L expressed by the following Expression (1). However, the loss function is not limited to Expression (1), and may be a loss function that brings the inference results forming a positive pair close and brings the inference results forming a negative pair away.

$$\begin{matrix}[ Math . 1 ] & \\ ℒ = {\sum }_{n = 1}^{N} ( α \cdot {ℒ}_{n}^{a} + β \cdot {ℒ}_{n}^{b} ) & ( 1 )\end{matrix}$$

Here, “L^{a}ₙ” in the first term of Expression (1) indicates a loss function regarding the n-th (n=1, . . . , N) clip video of the first camera, and is expressed by the following Expression (2). α is a hyperparameter for adjusting the weight of Lan.

$$\begin{matrix}[ Math . 2 ] & \\ {ℒ}_{n}^{a} = log \frac{exp ( d ( {p}_{n}^{a} , {p}_{n}^{b} ) / τ )}{{\sum }_{k = 1}^{N} ( {𝟙}_{k \neq n} exp ( d ( {p}_{n}^{a} , {p}_{k}^{a} ) / τ ) + exp ( d ( {p}_{n}^{a} , {p}_{k}^{b} ) / τ ) )} & ( 2 )\end{matrix}$$

Here, “d” represents a distance function (for example, a mean square error), “p^{a}ₙ” and “p^{a}ₖ” represent an inference result for the n-th or k-th clip video of the first camera, “p^{b}ₙ” and “p^{b}ₖ” represent an inference results for the n-th or k-th clip video of the second camera, and “τ” represents a temperature parameter that is a hyperparameter. “l_{k≠n}” is a function that returns l when k≠n and 0 when k=n. Expression (2) represents a loss related to the inference result based on the n-th clip video of the first camera. Specifically, Expression (2) represents a cross entropy loss using the distance of the positive pair inference result and the distance of the negative pair inference result based on the n-th clip video of the first camera. As a result, training is performed such that the inference result forming a positive pair is brought closer and the inference result forming a negative pair is moved away. As described in the example of FIG. 3, the inference result of the negative pair is an inference result based on the clip video generated by the same camera or different cameras having at least one of the subject and the photographing period different from each other.

“L^{b}ₙ” in the second term of Expression (1) is relevant to a loss function related to the clip video of the second camera among the nth set of positive pair clip videos, and is expressed by the following Expression (3). β is a hyperparameter for adjusting the weight of L^{b}ₙ.

$$\begin{matrix}[ Math . 3 ] & \\ {ℒ}_{n}^{b} = log \frac{exp ( d ( {p}_{n}^{b} , {p}_{n}^{a} ) / τ )}{{\sum }_{k = 1}^{N} ( {𝟙}_{k \neq n} exp ( d ( {p}_{n}^{b} , {p}_{k}^{b} ) / τ ) + exp ( d ( {p}_{n}^{b} , {p}_{k}^{a} ) / τ ) )} & ( 3 )\end{matrix}$$

Here, Expression (3) represents a loss regarding the inference result based on the n-th clip video of the second camera. Specifically, the expression represents a cross entropy loss using the distance of the positive pair inference result and the distance of the negative pair inference result based on the n-th clip video of the second camera.

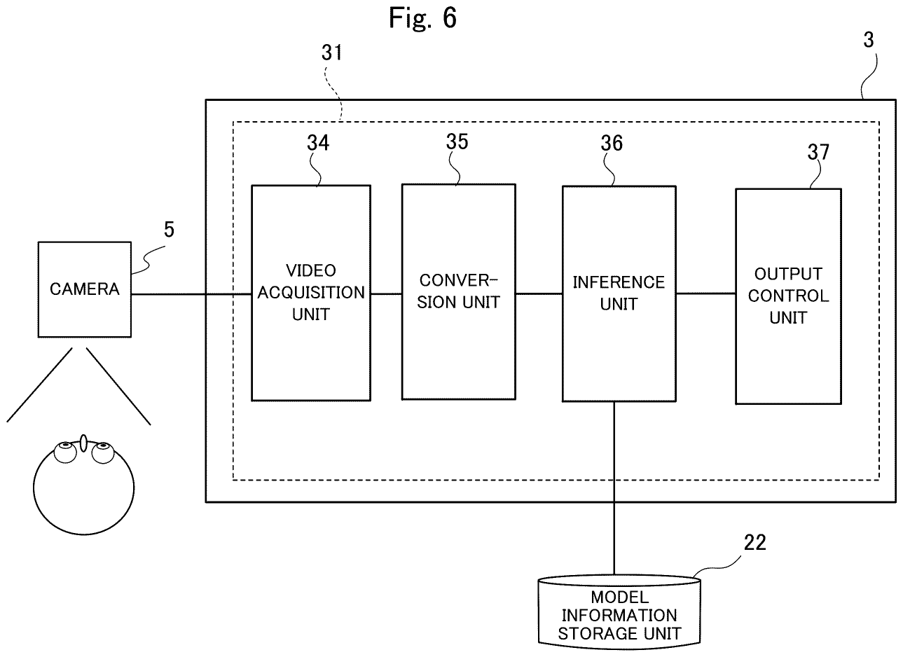

FIG. 6 is an example of functional blocks of the estimation device 3 related to the estimation processing of the vital information using the inference model trained by the training device 1. As illustrated in FIG. 6, the processor 31 of the estimation device 3 functionally includes a video acquisition unit 34, a conversion unit 35, an inference unit 36, and an output control unit 37. While blocks that exchange data with each other are connected by a solid line in FIG. 6, a combination of the blocks that exchange data with each other is not limited thereto. The same applies to diagrams of other functional blocks described later.

The video acquisition unit 34 acquires, from the camera 5, video data obtained by photographing the face of a person who is a subject. Here, the camera 5 may be a first camera used for training or a second camera. Then, the video acquisition unit 34 extracts a video clip having a format that can be converted by the conversion unit 35 from the acquired video data, and supplies the extracted video clip to the conversion unit 35.

The conversion unit 35 generates a spatiotemporal map obtained by converting the video clip supplied from the video acquisition unit 34. The processing of the conversion unit 35 is the same as the processing of the conversion unit 15. The conversion unit 35 supplies the generated spatiotemporal map to the inference unit 36.

The inference unit 36 generates an inference result of the vital information based on the model information of the inference model relevant to the camera 5 and the spatiotemporal map supplied from the conversion unit 35. In this case, the inference unit 36 reads the trained parameter of the inference model relevant to the camera 5 from the model information storage unit 22, and acquires the inference result of the vital information output by the inference model by inputting the spatiotemporal map to the inference model to which the trained parameter is applied. In a case where the data output by the inference model is a waveform such as a pulse wave or a respiratory waveform, the inference unit 36 may further execute processing for converting the data into a heart rate, a respiratory rate, or the like. The inference unit 36 supplies an inference result of the generated vital information to the output control unit 37.

The output control unit 37 performs processing of outputting an inference result of the vital information supplied from the inference unit 36 as the estimated vital information. In this case, the output control unit 37 may display or output the estimated vital information by sound using an output device such as a display or a speaker, or may store or transmit the vital information to the storage device 2 or another device.

Each component of the data augmentation unit 14, the conversion unit 15, the inference unit 16, and the training unit 17 can be implemented, for example, by the processor 11 executing a program. Similarly, each component of the conversion unit 35, the inference unit 36, and the output control unit 37 can be implemented, for example, by the processor 31 executing a program. Each component may also be achieved by recording a necessary program in an optional nonvolatile storage medium and installing the program as necessary. At least a part of these components is not limited to be achieved by software by a program, and may be achieved by a combination of any of hardware, firmware, and software, or the like. At least a part of these components may be achieved using, for example, a user-programmable integrated circuit such as a field-programmable gate array (FPGA) or a microcontroller. In this case, a program including the above components may be achieved by using the integrated circuit. At least a part of the components may include an application specific standard product (ASSP), an application specific integrated circuit (ASIC), or a quantum processor (quantum computer control chip). In this manner, the components may be achieved by various types of hardware. The same applies to other example embodiments described later. These components may also be achieved by, for example, cooperation of a plurality of computers by using a cloud computing technology or the like.

### (5) Processing Flow

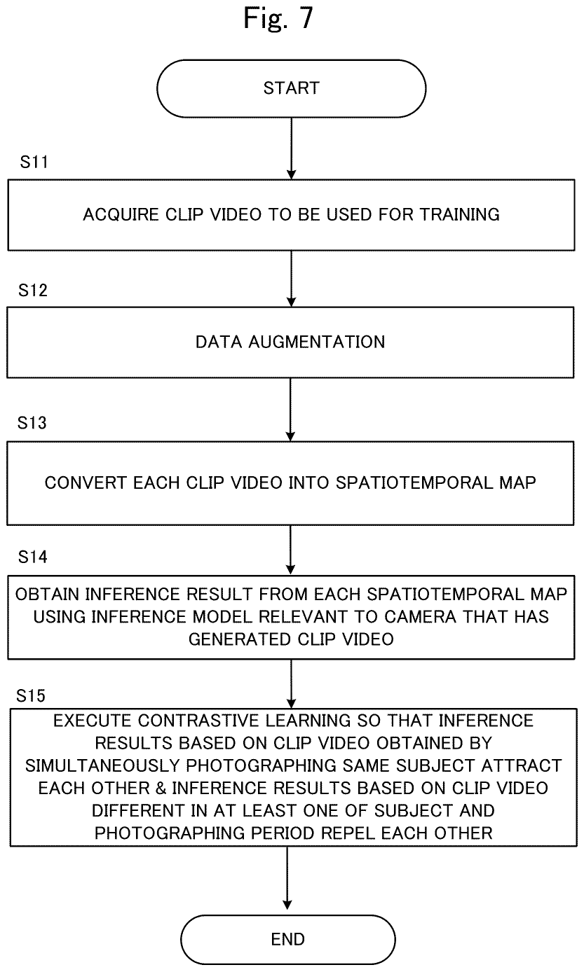

FIG. 7 is an example of a flowchart illustrating a processing procedure by the training device 1.

First, the training device 1 acquires the clip video to be used for training from the training data storage unit 21 (step S11). Then, the training device 1 applies data augmentation to the clip video acquired in step S11 (step S12). As a result, the training device 1 generates the augmented clip video using the clip video acquired in step S11 as the original clip video. In this case, the training device 1 applies the same data augmentation to the original clip video in the positive pair to generate the augmented clip video in the positive pair.

Then, the training device 1 converts each piece of video data (including the original clip video and the augmented clip video) into the spatiotemporal map (step S13). Next, the training device 1 acquires the inference result regarding the vital information from each spatiotemporal map by using the inference model relevant to the camera that has generated the clip video that is the source of each spatiotemporal map (step S14). As a result, the inference result of the inference model relevant to each of the spatiotemporal maps acquired in step S13 is obtained.

Then, the training device 1 performs contrastive learning of the inference model so that the inference results based on the clip video obtained by simultaneously photographing the same subject attract each other and the inference results based on the clip video in which at least one of the subject and the photographing period is different repel each other (step S15). In this case, for example, the training device 1 determines the parameter of each inference model so that the loss function indicated in Expression (1) is minimized, and updates the model information of each inference model stored in the model information storage unit 22 with the determined parameter.

### (6) Modifications

Next, modifications applicable to the above-described example embodiments will be described. The following modifications may be implemented in any combination.

### (First Modification)

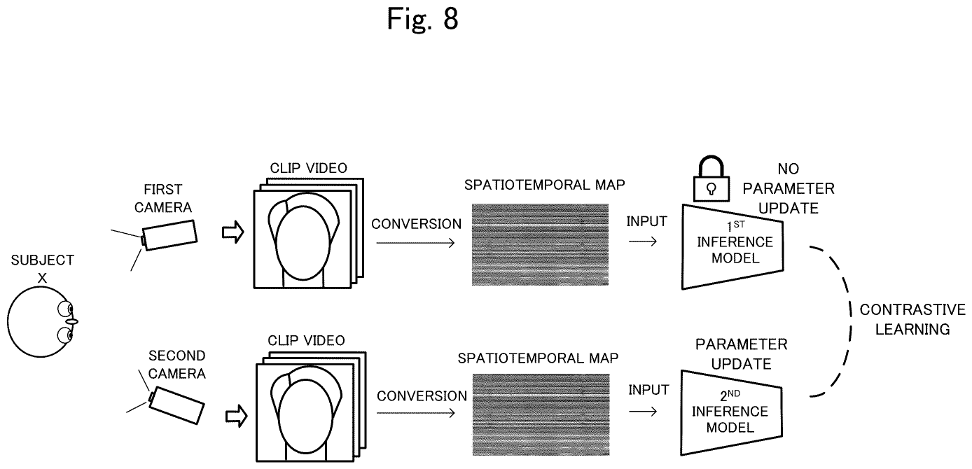

When one of the first inference model and the second inference model is a trained inference model, only the other inference model may be trained by contrastive learning based on the present example embodiment. Hereinafter, for convenience of description, it is assumed that the first inference model is a trained inference model. FIG. 8 illustrates an outline of training of an inference model in the first modification.

In this case, the first inference model is trained in advance by a training data set including a plurality of records serving as a set of the clip video generated by the first camera and the supervised label (correct answer label) indicating the correct answer to be output by the first inference model when the clip video is input, and the trained parameter is stored in the model information storage unit 22. The supervised label is, for example, data acquired from a sensor (e.g. pulse wave sensor, breathing band) that senses vital information of the subject at the time of photographing the clip video.

Then, the training device 1 executes the flowchart illustrated in FIG. 7. In this case, in step S15, the parameters of the first inference model are fixed, and the parameters of the second inference model are changed so as to minimize the loss function illustrated in Expression (1) or the like. The training device 1 may further train the first inference model without fixing the parameter of the first inference model. That is, the training device 1 may change both the parameters of the first inference model and the second inference model so as to minimize the loss function indicated in Expression (1) or the like.

### (Second Modification)

The inference model may be a model having three-dimensional feature information (three-dimensional feature map) as input data instead of a model having, as input data, a spatiotemporal map which is two-dimensional feature information.

In this case, the inference model is a model trained to output the inference result of the vital information based on the clip video when the three-dimensional feature information based on the clip video is input. Then, for example, the training device 1 generates three-dimensional feature information having three axes relevant to a two-dimensional spatial direction (that is, the same two-dimensional coordinate axes as the image) and a temporal direction from the video clip in step S13 of FIG. 7, and the training device 1 acquires an inference result of the vital information from the inference model by inputting the three-dimensional feature information to the inference model in step S14.

The input data of the inference model is not limited to two-dimensional or three-dimensional feature information, and may be input data in an arbitrary format represented by a tensor.

### (Third Modification)

The training data storage unit 21 may include measurement data generated by a sensor other than the camera in addition to the clip video generated from the camera.

Examples of such a sensor include a microphone that collects a sound related to a heart sound or a breathing sound of the subject, a temperature sensor that measures a temperature related to breathing of the subject, and the like. In this case, the training data storage unit 21 includes measurement data measured by the sensor at the same time as each clip video. Then, in step S13 of FIG. 7, the training device 1 converts each clip video and the measurement data generated at the same time as each clip video into a spatiotemporal map. According to this aspect, the training device 1 can train an inference model using information other than video.

### (Fourth Modification)

The training data storage unit 21 may store video clips generated from three or more cameras.

In this case, for example, assuming that the number of cameras is “Nc”, the training device 1 forms _{Nc}C₂ pairs of cameras, and performs contrastive learning of the inference model relevant to each pair of cameras for each pair. In this case, the training device 1 acquires the clip video of the target pair of cameras in step S11 of the flowchart of FIG. 7, acquires the inference result using the inference model relevant to the target pair of cameras in step S14, and trains the parameter of the inference model relevant to the target pair of cameras based on the inference result in step S15. In step S15, the training device 1 may define a comprehensive loss function relevant to the Nc cameras and determine parameters of the Nc inference models relevant to the Nc cameras so as to minimize the loss function. The loss function used in this case may be, for example, a loss function obtained by adding _{Nc}C₂ loss functions of Expression (1) relevant to the _{Nc}C₂ pairs of cameras.

### (Fifth Modification)

The training device 1 may train one inference model that functions as the first inference model and the second inference model. In this case, the first inference model and the second inference model are common inference models regardless of the camera.

In this case, model information of one inference model is stored in the model information storage unit 22, and the training device 1 acquires an inference result from each spatiotemporal map using one inference model configured with reference to the model information storage unit 22 in step S14 of FIG. 7. Then, in a case where the contrastive learning is performed in step S15 of FIG. 7, the training device 1 updates the parameter of the one inference model described above so as to bring the inference result based on the clip video of the positive example closer and move the inference result based on the clip video of the negative example away.

According to the present modification, the training device 1 can train an inference model that does not depend on individual cameras.

### (Sixth Modification)

The inference model is not limited to the model that outputs the inference result regarding the vital information of the subject that is the subject of the clip video input to the inference model, and may be a model that outputs the inference result regarding arbitrary state information of the subject. In this case, examples of the state information include information regarding an arbitrary mental state such as stress of the subject and information regarding an appearance state of the subject (for example, a degree of swelling).

### (Seventh Modification)

For example, the estimation device 3 may determine a coping method to be presented to the subject based on the inference result of the vital information (or other state information based on the sixth modification) output by the inference model based on the clip video of the subject.

In this case, the estimation device 3 determines a coping method to be presented to the subject based on a model generated by machine learning of the correspondence relationship between the estimated vital information and the coping method and the estimated vital information of the subject. The trained parameters of the above-described model are stored in advance in the storage device 2, the memory 32, or the like, for example. The method of determining the coping method is not limited to the above-described method. In this manner, the inference model obtained by training can be used for assistance of decision making of the user (health care workers (a doctor, a nurse, a public health nurse, a laboratory technician, a therapist, a trainee, and the like), public health nurses, health care professionals, etc.) or the like.

### Second Example Embodiment

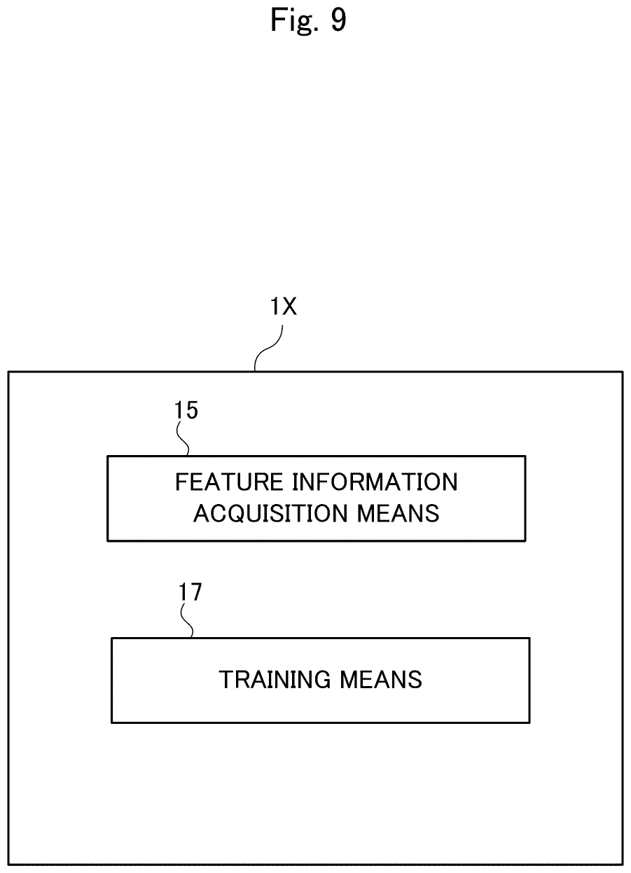

FIG. 9 illustrates the schematic configuration of the training device 1X according to the second example embodiment. The training device 1X mainly includes a feature information acquisition means 15X and a training means 17X. The training device 1X may be configured by plural devices.

The feature information acquisition means 15X is configured to acquire first feature information that is spatiotemporal feature information generated from a first video obtained by photographing a subject by a first camera, and acquiring second feature information that is the feature information generated from a second video obtained by photographing the subject by a second camera. Examples of the feature information acquisition means 15X include the conversion unit 15 according to the first example embodiment. In another example, the feature information acquisition means 15X may receive the first feature information and the second feature information from a device, other than the training device 1X, which generates the above-mentioned feature information.

The training means (learning means) 17X is configured to train, based on the first feature information and the second feature information, an inference model that infers a relationship between the feature information and state information of the subject. In this case, the training means 17X is configured to perform the training using, as a positive pair, the first feature information and the second feature information which are based on videos obtained by photographing the same subject in a same period. Examples of the training means 17X include the training means 17 according to the first example embodiment.

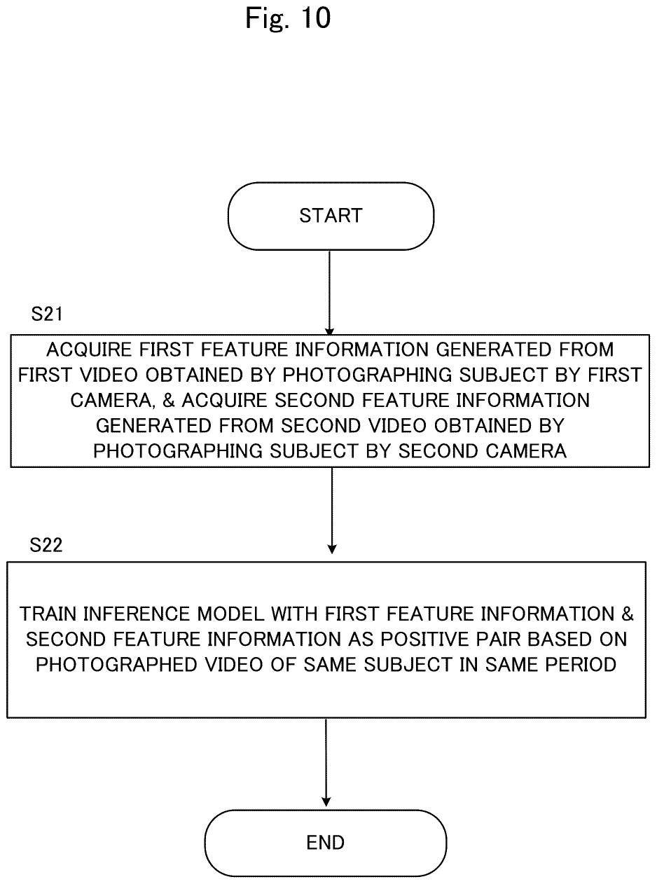

FIG. 10 illustrates an example of the flowchart indicating the procedure of the process executed by the training device 1X according to the second example embodiment. The feature information acquisition means 15X acquires first feature information that is spatiotemporal feature information generated from a first video obtained by photographing a subject by a first camera, and acquiring second feature information that is the feature information generated from a second video obtained by photographing the subject by a second camera (step S21). The training means 17X trains, based on the first feature information and the second feature information, an inference model that infers a relationship between the feature information and state information of the subject, wherein the training means 17X perform the training using, as a positive pair, the first feature information and the second feature information which are based on videos obtained by photographing the same subject in a same period (step S22).

The training device 1X according to the second example embodiment can suitably train the inference model using feature information which is based on videos obtained by photographing the same subject during the same period.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

### [Supplementary Note 1]

A training device comprising:
a feature information acquisition means for acquiring first feature information that is spatiotemporal feature information generated from a first video obtained by photographing a subject by a first camera, and acquiring second feature information that is the feature information generated from a second video obtained by photographing the subject by a second camera; and
a training means for training, based on the first feature information and the second feature information, an inference model that infers a relationship between the feature information and state information of the subject,
wherein the training means performs the training using, as a positive pair, the first feature information and the second feature information which are based on videos obtained by photographing the same subject in a same period.

### [Supplementary Note 2]

The training device according to Supplementary Note 1, comprising:
a first inference means for generating a first inference result regarding the state information, based on the first feature information and a first inference model that infers a relationship between the first feature information and the state information; and
a second inference means for generating a second inference result regarding the state information, based on the second feature information and a second inference model that infers a relationship between the second feature information and the state information,
wherein the training means trains, based on the first inference result and the second inference result, at least one of the first inference model or the second inference model.

### [Supplementary Note 3]

The training device according to Supplementary Note 2, wherein the training means performs contrastive learning of at least one of the first inference model or the second inference model, based on the first inference result and the second inference result.

### [Supplementary Note 4]

The training device according to Supplementary Note 2, wherein the training means updates parameters on at least one of the first inference model or the second inference model so that the first inference result and the second inference result attract each other,
the first inference result and the second inference result being generated based on the first feature information and the second feature information forming the positive pair.

### [Supplementary Note 5]

The training device according to Supplementary Note 3 or 4, wherein the training means updates parameters on at least one of the first inference model or the second inference model so that the first inference result and the second inference result repel each other,
the first inference result and the second inference result being generated based on the first feature information and the second feature information based on videos in which at least one of the subject or a photographing period is different.

### [Supplementary Note 6]

The training device according to Supplementary Note 2, wherein
the first inference model is a trained model, and
the training means performs training of the second inference model based on the first inference result and the second inference result.

### [Supplementary Note 7]

The training device according to Supplementary Note 2, wherein the training means performs training of one inference model functioning as the first inference model and the second inference model.

### [Supplementary Note 8]

The training device according to Supplementary Note 1, further comprising a data augmentation means for generating a first augmented video and a second augmented video by applying common data augmentation to the first video and the second video relevant to the first feature information and the second feature information forming the positive pair,
wherein the training means performs the training using the first feature information based on the first augmented video and the second feature information based on the second augmented video as a positive pair.

### [Supplementary Note 9]

The training device according to Supplementary Note 2, wherein
the feature information acquisition means acquires third feature information that is the feature information generated from a third video obtained by photographing the subject with a third camera,
the training device comprises a third inference means for generating a third inference result regarding the state information based on the third feature information and a third inference model that infers a relationship between the third feature information and the state information, and
the training means performs training of at least one of the first inference model, the second inference model, or the third inference model, based on the first inference result, the second inference result, and the third inference result.

### [Supplementary Note 10]

The training device according to Supplementary Note 1, wherein the state information is at least one of information regarding a vital parameter of the subject, information regarding a mental state of the subject, or information regarding an appearance state of the subject.

### [Supplementary Note 11]

A training method by a computer, comprising:
acquiring first feature information that is spatiotemporal feature information generated from a first video obtained by photographing a subject by a first camera, and acquiring second feature information that is the feature information generated from a second video obtained by photographing the subject by a second camera; and
training, based on the first feature information and the second feature information, an inference model that infers a relationship between the feature information and state information of the subject,
performing the training using, as a positive pair, the first feature information and the second feature information which are based on videos obtained by photographing the same subject in a same period.

### [Supplementary Note 12]

A storage medium storing a program for causing a computer to execute processing comprising:
acquiring first feature information that is spatiotemporal feature information generated from a first video obtained by photographing a subject by a first camera, and acquiring second feature information that is the feature information generated from a second video obtained by photographing the subject by a second camera; and
training, based on the first feature information and the second feature information, an inference model that infers a relationship between the feature information and state information of the subject,
performing the training using, as a positive pair, the first feature information and the second feature information which are based on videos obtained by photographing the same subject in a same period.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1X Training device
2 Storage device
3 Estimation device
5 Camera
11, 31 Processor
12, 32 Memory
13, 33 Interface
21 Training data storage unit
22 Model information storage unit
100 Vital information estimation system

What is claimed is:

1. A training device comprising:
at least one memory configured to store instructions; and
at least one processor configured to execute the instructions to:
acquire first feature information that is spatiotemporal feature information generated from a first video obtained by photographing a subject by a first camera, and acquiring second feature information that is the feature information generated from a second video obtained by photographing the subject by a second camera; and
train, based on the first feature information and the second feature information, an inference model that infers a relationship between the feature information and state information of the subject, through machine learning
using, as a positive pair, the first feature information and the second feature information which are based on videos obtained by photographing the same subject in a same period.

2. The training device according to claim 1,
wherein the at least one processor is configured to execute the instructions to
generate a first inference result regarding the state information, based on the first feature information and a first inference model that infers a relationship between the first feature information and the state information,
generate a second inference result regarding the state information, based on the second feature information and a second inference model that infers a relationship between the second feature information and the state information, and
train, based on the first inference result and the second inference result, at least one of the first inference model or the second inference model.

3. The training device according to claim 2, wherein the at least one processor is configured to execute the instructions to perform contrastive learning of at least one of the first inference model or the second inference model, based on the first inference result and the second inference result.

4. The training device according to claim 2, wherein the at least one processor is configured to execute the instructions to update parameters on at least one of the first inference model or the second inference model so that the first inference result and the second inference result attract each other,
the first inference result and the second inference result being generated based on the first feature information and the second feature information forming the positive pair.

5. The training device according to claim 3, wherein the at least one processor is configured to execute the instructions to update parameters on at least one of the first inference model or the second inference model so that the first inference result and the second inference result repel each other,
the first inference result and the second inference result being generated based on the first feature information and the second feature information based on videos in which at least one of the subject or a photographing period is different.

6. The training device according to claim 2, wherein
the first inference model is a trained model, and
the at least one processor is configured to execute the instructions to perform training of the second inference model based on the first inference result and the second inference result.

7. The training device according to claim 2, wherein the at least one processor is configured to execute the instructions to perform training of one inference model functioning as the first inference model and the second inference model.

8. The training device according to claim 1, wherein the at least one processor is configured to execute the instructions to
generate a first augmented video and a second augmented video by applying common data augmentation to the first video and the second video relevant to the first feature information and the second feature information forming the positive pair, and
perform the training using the first feature information based on the first augmented video and the second feature information based on the second augmented video as a positive pair.

9. The training device according to claim 2, wherein
the at least one processor is configured to execute the instructions to
acquire third feature information that is the feature information generated from a third video obtained by photographing the subject with a third camera,
generate a third inference result regarding the state information based on the third feature information and a third inference model that infers a relationship between the third feature information and the state information, and
perform training of at least one of the first inference model, the second inference model, or the third inference model, based on the first inference result, the second inference result, and the third inference result.

10. The training device according to claim 1, wherein the state information is at least one of information regarding a vital parameter of the subject, information regarding a mental state of the subject, or information regarding an appearance state of the subject.

11. A training method by a computer, comprising:
acquiring first feature information that is spatiotemporal feature information generated from a first video obtained by photographing a subject by a first camera, and acquiring second feature information that is the feature information generated from a second video obtained by photographing the subject by a second camera; and
training, based on the first feature information and the second feature information, an inference model that infers a relationship between the feature information and state information of the subject,
performing the training using, as a positive pair, the first feature information and the second feature information which are based on videos obtained by photographing the same subject in a same period.

12. A non-transitory computer readable storage medium storing a program for causing a computer to execute processing comprising:
acquiring first feature information that is spatiotemporal feature information generated from a first video obtained by photographing a subject by a first camera, and acquiring second feature information that is the feature information generated from a second video obtained by photographing the subject by a second camera; and
training, based on the first feature information and the second feature information, an inference model that infers a relationship between the feature information and state information of the subject,
performing the training using, as a positive pair, the first feature information and the second feature information which are based on videos obtained by photographing the same subject in a same period.
